(19) United States
(12) Patent Application Publication
(10) Pub. No.: US 2024/0206520 A1
(43) Pub. Date: Jun. 27, 2024

(54) MACHINE FOR THREE-DIMENSIONAL BREADING OF FOOD

(71) Applicant: Geunyoung YI, Cheonan-si (KR)

(72) Inventor: Geunyoung YI, Cheonan-si (KR)

(21) Appl. No.: 18/288,359

(22) PCT Filed: Apr. 21, 2022
(86) PCT No.: PCT/KR2022/005680

§ 371 Date: Oct. 25, 2023

(30) Foreign Application Priority Data
Apr. 30, 2021 (KR) 10-2021-0056116

(51) Int. Cl. A23P 20/12

(52) U.S. Cl. CPC A23P 20/12

(57) ABSTRACT

The present invention relates to a machine for three-dimensional breading of food and, more specifically, to a machine for three-dimensional breading of food, the machine pressurizing the upper surface and both sides of food at the same time when breaded food is pressurized for breading, so as to prevent the food from being deformed in a specific direction by pressing, allowing pressure to be evenly applied in all directions of the food to enable firmer coating of flour such as wet bread crumbs, which do not adhere relatively well to the surface of food, and enabling various types of food to be coated.

### TECHNICAL FIELD

The present invention relates to a machine for three-dimensional breading of food and, more specifically, to a machine for three-dimensional breading of food, the machine pressurizing the upper surface and both sides of food at the same time when breaded food is pressurized for breading, so as to prevent the food from being deformed in a specific direction by pressing, allowing pressure to be evenly applied in all directions of the food to enable firmer coating of flour such as wet breadcrumbs, which do not adhere relatively well to the surface of food, and enabling various types of food to be coated.

### BACKGROUND TECHNOLOGY

Most types of foods that are fried in oil, such as croquet and pork cutlet, are preferred by all ages, regardless of children and adults.

For example, pork cutlet is a dish that pork is cut into a predetermined size and is prepared by gently softening it while spreading it wide, and the prepared pork is fried in oil after coating it with flour dough, breadcrumbs, and seasoning, and eaten with various sauces, and croquette is a dish that is eaten by mixing minced meat and vegetables and coating and frying breadcrumbs on the main ingredient.

It is common to consume these frying foods produced and distributed in an automated system in general households, and to cook and consume them directly by frying them without making and eating them by hand at ordinary households.

In addition, even in general restaurants, frying foods are sold by being directly delivered, fried-treated and post-treated, and the demand is gradually increasing.

Accordingly, the development of a system for automatically manufacturing the frying food is actively being studied, and a bread crumb coating apparatus structure for the automated manufacture of frying food (pork cutlet) has been proposed in Registered Patent No. 10-1981383 (hereinafter referred to as a bread crumb coating apparatus, a prior art) filed and registered by this applicant.

To briefly explain this, the prior art includes a moving body in which the breadcrumbs are dispersed on the surface and pork is moved from the insertion unit to the discharge unit, and a pork presser mounted on one side of the moving body and pressing the upper surface of breadcrumb coated pork while moving along the moving body through the operation of a driving source of operating the moving body when the port is moved from the insertion unit to the discharge unit, and at this time, the pork presser includes a presser that presses the breadcrumb coated pork from the upper part.

In other words, in the prior art, since the presser operated up and down and pressurized the pork only at the upperpart, the breadcrumbs on both sides of the pork are not properly coated on the pork. Accordingly, due to the absence of breadcrumbs on the side of the pork, there was a problem that the commerciality was significantly reduced, such as the peeling of the fried clothes easily after a fried-treatment or the shape of the food being deformed.

In addition, in the case of wet breadcrumbs, breadcrumbs particles are less cohesive and do not stick well to the surface of the food, and thus, they are usually worked by excessively pressing them when coated on the food, and when pressed on the food due to excessive pressure, the texture and taste deteriorated after the fried treatment.

### Patent Document

(Patent Document 0001) Registered Patent No. 10-1981383

### CONTENT OF INVENTION

### Task to be Solved

This invention was created to solve this problem in consideration of all the problems of the prior art. When pressing food with the breadcrumbs, the upper surface and both sides of the food are simultaneously pressed to prevent the shape of the food from being deformed in a specific direction by pressing pressure, and the pressing force is applied evenly in all directions of the food, so that the breadcrumbs such as wet breadcrumbs that do not stick relatively well to the surface of the food can be coated more firmly, simultaneously, it aims to provide a powder coating apparatus for food that can be applied to various types of foods without difficulty.

### Solution Means of the Problem

The present disclosure is a means to achieve the above object, characterized by comprising: a transfer conveyor that transports food in a row; a bread crumb supply unit that sprays powder on the food that transfers in a row, at the top of the above transfer conveyor; and a pressure part installed on the path of the above transfer conveyor and presses the upper and side of the powdered food to bring the powder into close contact with the food.

In addition, the above pressure part comprises a pair of side surface pressure units that are installed to face each other with the transfer conveyor in between and press both sides of the food being transferred from the transfer conveyor; and an upper surface pressure unit that presses the upper surface of the food passing through the pair of side surface pressure units.

In addition, a pressurized space is formed among the pair of side surface pressure units, upper surface pressure units, and transfer conveyors, and powder is closely attached to both sides and upper surfaces of the food in the pressurized space.

In addition, the left and right width of the pressurized space is adjusted to become wider or narrower toward the rear end.

In addition, the upper and lower heights of the pressurized space are adjusted to rise or fall toward the rear end.

In addition, each of the pair of side pressing units includes a guide plate in which a driving roll mounting hole and a driving roll mounting hole are formed at the front and rear ends, a side driving roller rotatably coupled to the driving roll mounting hole in place, a side driven roller rotatably coupled to the driving roll mounting hole in place, a side pressure motor coupled to the side driving roller to rotatably drive the side driving roller; and a side pressure belt wound around the side driving roller and the side driven roller in the form of an infinite orbit.

### Effects of the Invention

According to the present disclosure, a coating apparatus constitutes a pressurized space in which the powder is pressed and adhered to the surface of the food, and when the food passes through this pressurized space, the upper surface and both sides are pressed at the same time, thereby suppressing the shape of the food coated with the powder from being deformed in a specific direction, thereby completely preserving the shape of the food. Since the powder on the food is evenly pressed on the upper and side of the food, the powder is uniformly coated around the food, and even after it is coated, there is little shape deformation of the food, thereby ensuring marketability.

In addition, a pressing force is applied step by step to food entering the pressurized space due to the structure of the pressurized space that gradually narrows the width. Accordingly, a large amount of powder can be adhered more closely to the surface of the food while preventing the deformation of the food, and powder such as wet bread powder that does not stick relatively well to the surface of the food can be coated more firmly.

In addition, since the coating apparatus according to the present disclosure can appropriately change the volume of the pressurized space, the powder can be coated on the food without difficulty, even if the type, shape, and size of the food vary.

### BRIEF DESCRIPTION OF THE DRAWINGS

FIG. 1 shows the overall appearance of the powder coating apparatus for food according to the present disclosure.

FIG. 2 shows a plan view of the powder coating apparatus for food according to the present disclosure.

FIG. 3 shows one side of the powder coating apparatus for food according to the present disclosure.

FIG. 4 shows an appearance of the main part of the powder coating apparatus for food according to the present disclosure.

FIG. 5 shows the front of FIG. 4.

FIG. 6 shows a schematic decomposition configuration of a side pressing unit.

FIG. 7 is a diagram illustrating the action of the side pressing unit.

FIG. 8 shows a tension control process of the side pressure belt.

FIG. 9 shows a schematic decomposition configuration of the upper pressing unit.

FIG. 10 illustrates the action of the upper pressing unit.

### DETAILED DESCRIPTION OF THE EMBODIMENTS

In order to fully understand the present disclosure, preferred embodiments of this invention will be described with reference to the accompanying drawings.

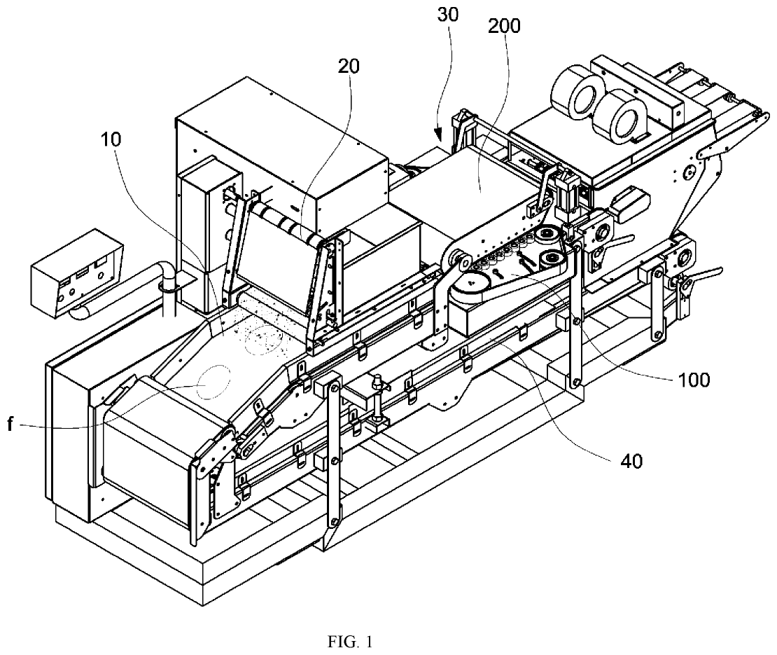

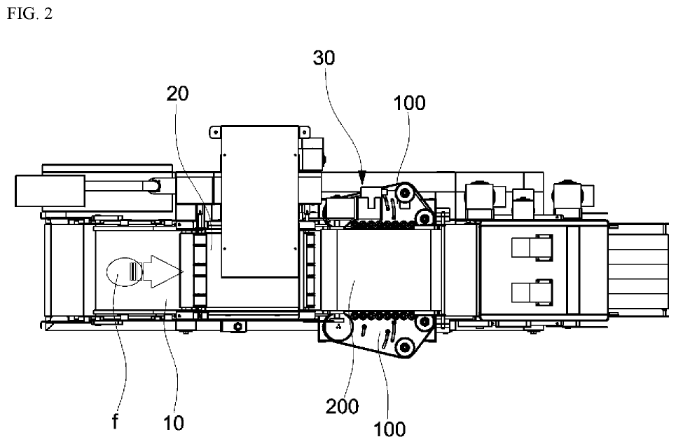

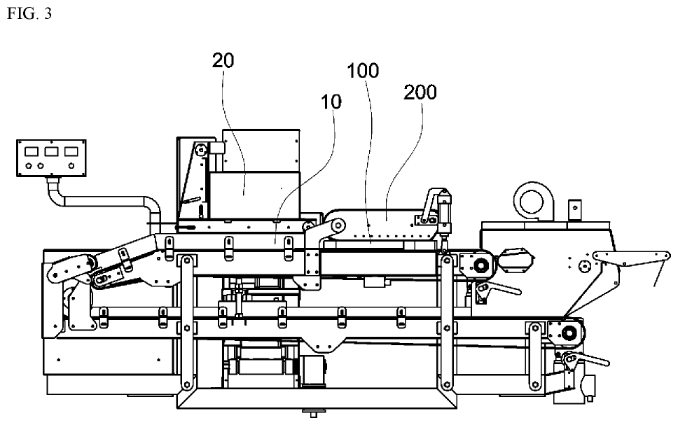

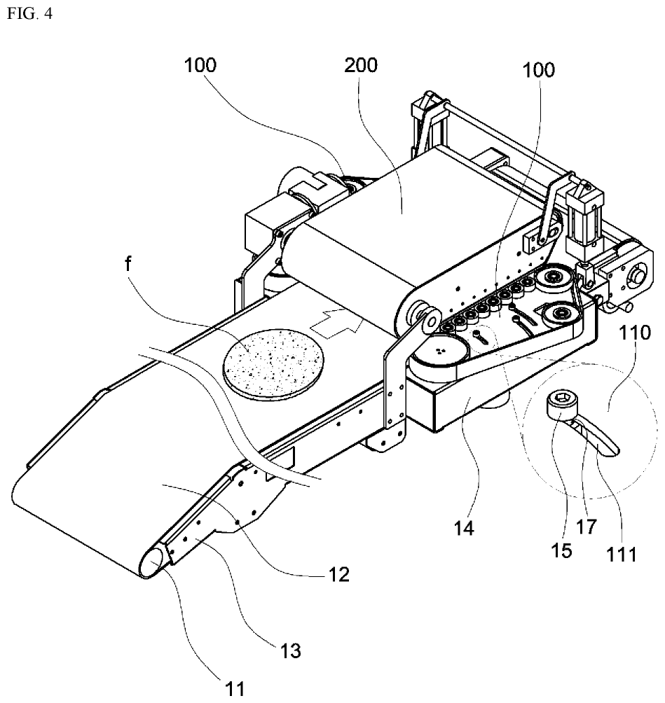

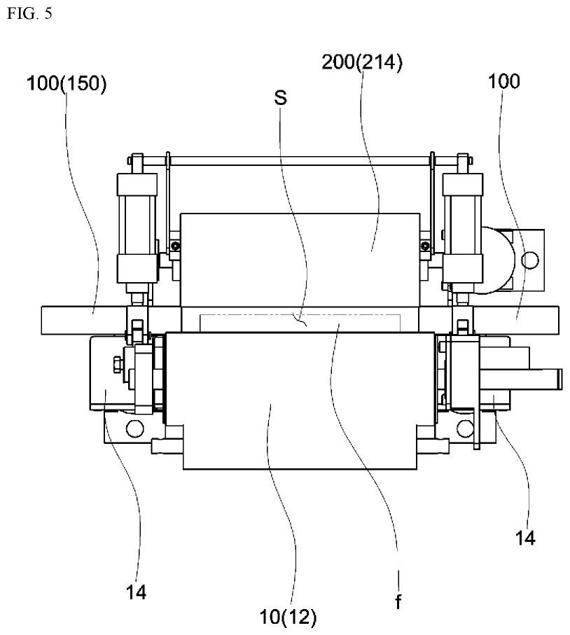

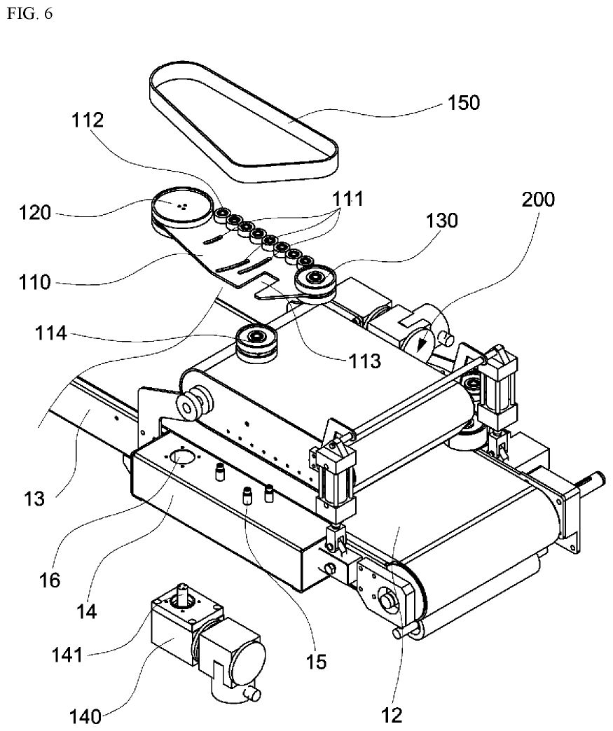

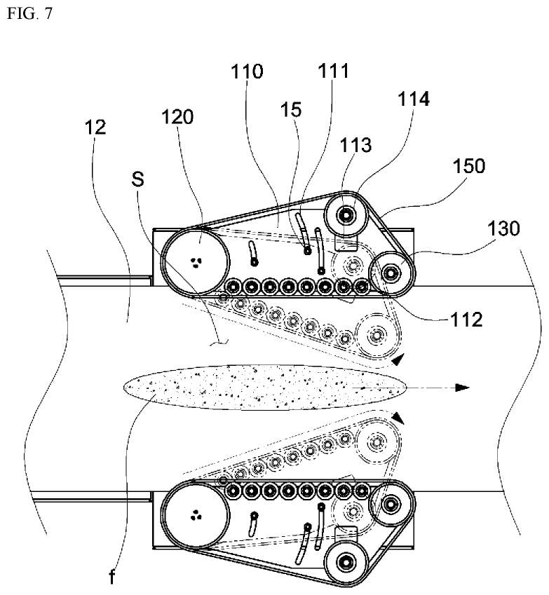

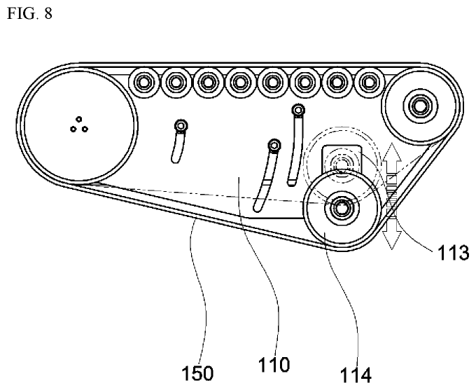

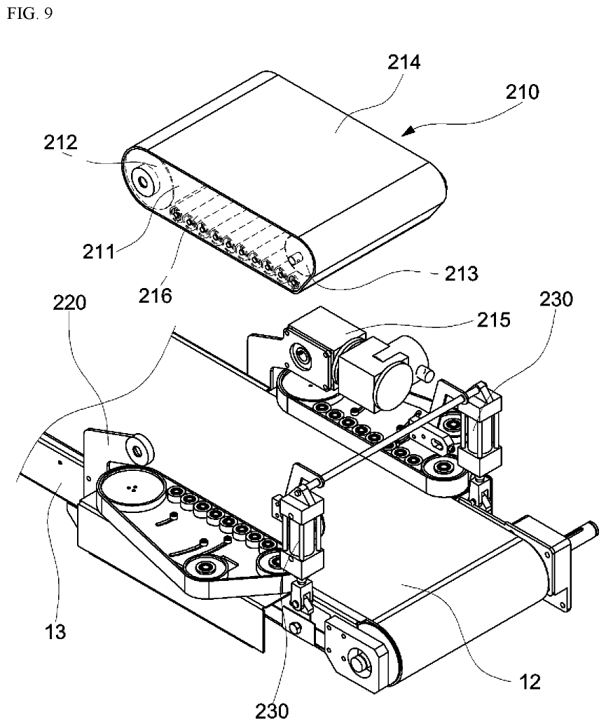

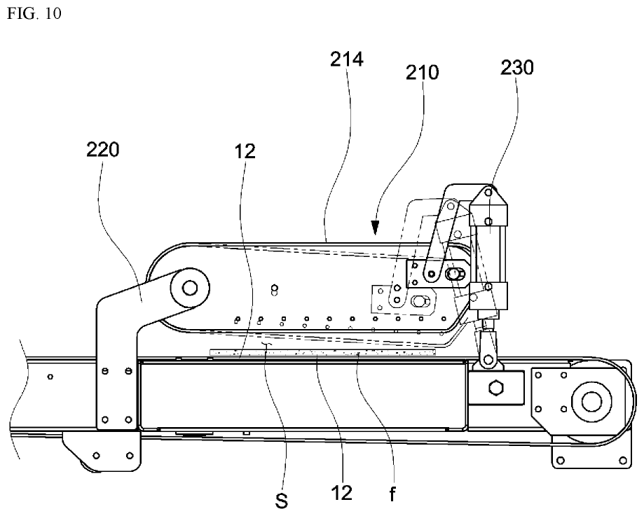

The accompanying FIG. 1 shows the overall appearance of the powder coating apparatus for food according to the present disclosure, FIG. 2 shows a plan view of the powder coating apparatus for food according to the present disclosure, FIG. 3 shows one side of the powder coating apparatus for food according to the present disclosure, FIG. 4 shows an appearance of the main part of the powder coating apparatus for food according to the present disclosure, FIG. 5 shows the front of FIG. 4, FIG. 6 shows a schematic decomposition configuration of a side pressing unit. FIG. 7 is a diagram illustrating the action of the side pressing unit, FIG. 8 shows a tension control process of the side pressure belt, FIG. 9 shows a schematic decomposition configuration of the upper pressing unit, and FIG. 10 illustrates the action of the upper pressing unit.

The embodiments of the present disclosure may be modified into various forms in addition to the embodiments illustrated in the accompanying drawings, and the scope of the present disclosure should not be construed as being limited to the embodiments described in detail below. The present embodiment is provided to more completely explain the present disclosure to those with average knowledge in the art. Accordingly, the shape of the element in the drawing may be exaggerated to emphasize a clearer description. It should be noted that the same members in each drawing are sometimes shown with the same reference numerals. Detailed descriptions of known functions and configurations determined to unnecessarily obscure the gist of the present disclosure are omitted.

The powder coating apparatus for food according to the present disclosure (hereinafter, referred to as a coating apparatus) may be largely defined as including a transfer conveyor 10, a bread crumb supply unit 20, and a pressure part 30.

In this case, the transfer conveyor 10, the bread crumb supply unit 20, and the pressure part 30 may be supported in place on a support structure 40 that constitutes the overall skeleton of the coating apparatus.

On the other hand, the food (f) referred to in this invention should be understood as a concept that includes all foods that are fried-treated, such as chopped pork, croquette, hot dog, and various fried food ingredients as raw materials for pork cutlet.

First, the transfer conveyor 10 is responsible for transferring food (f) in a row. The transfer conveyor 10 is a conventional conveyor structure, and can be illustrated as including, for example, a pair of transfer rollers 11 that rotate by receiving rotational power, a transfer belt 12 that winds around the pair of transfer rollers 11 in an infinite orbit form, and a transfer frame 13 that supports the above transfer roller 11.

When food (f) is supplied to the front end of the transfer belt 12, the food (f) is transferred in a row and passes through the bread crumb supply unit 20 and the pressure part 30. After that, the food (f) discharged to the rear end of the transfer belt 12 is coated with bread crumb and can be delivered and packaged in a separate packaging device.

The bread crumb supply unit 20 is installed on the upper part of the above transfer conveyor 10 and is responsible for spraying breadcrumbs on the food (f) that transfers in a row from the transfer conveyor 10.

The breadcrumbs supplied from the bread crumb supply unit 20 may be a concept that includes various types of powder applied to food (f), such as breadcrumbs, flour, fried powder, and pancake powder.

The bread crumb supply unit 20 can be implemented in various ways in the line of supplying bread crumbs toward the food (f), for example, a structure that includes a powder storage container in which breadcrumbs are stored and a dispenser that continuously discharges breadcrumbs stored in the powder storage container by a certain amount, and detailed explanations below are omitted.

Since the coating apparatus according to the present disclosure has its main characteristics in the pressure part 30, the structure of the pressure part 30 will be explained in detail by referring to the accompanying drawings.

The pressure part 30 is installed on the path of the above transfer conveyor 10 and pressurizes the upper and side of the food (f) with bread flour to coat the food (f).

The food (f) that passes through the bread crumb supply unit 20 and has breadcrumbs on its surface passes through the pressure part 30 placed behind the bread crumb supply unit 20 and the upper and side surfaces can be pressed at the same time.

In other words, since the breadcrumbs on the food (f) are evenly pressed on the upper and side of the food (f), the breadcrumbs are uniformly coated around the food (f), and even after it is coated, there is little change in the shape of the food (f), ensuring marketability.

More specifically, the pressure part 30 may be illustrated as including a side surface pressure unit 100 and an upper surface pressure unit 200.

The side surface pressure unit 100 is installed so that a pair face each other left and right with the transfer conveyor 10 between them, and thus both sides of the food (f) being transferred from the transfer conveyor 10 can be pressed.

In this case, on the left and right sides of the transfer frame 13, an installing stand 14 may be provided to install the pair of side surface pressure units 100 respectively.

Next, the upper surface pressure unit 200 is formed directly above the side surface pressure unit 100 and presses the upper surface of the food (f) passing through the pair of side surface pressure units 100.

Accordingly, as shown in FIG. 5, a roughly square-shaped pressing space (S) is formed between the pair of side surface pressure units 100, the upper surface pressure unit 200, and the transfer conveyor 10, and the breadcrumbs may be closely attached to both sides and upper surfaces of the food (f) in the pressurized space (S).

In other words, when the food (f) passes through the pressurized space (S), the side surface pressure unit 100 and the upper surface pressure unit 200 act simultaneously on the food (f), resulting in pressure in the front-rear direction. Accordingly, the breadcrumbs on the surface may be uniformly adhered to the surface of the food (f) and coated.

Such a structure may be more effective in terms of preserving the appearance of the food (f) compared to a structure that individually presses the upper and side of the food (f). For example, in the case of a structure in which the upper surface of the food (f) is first pressed and then the side surface is continuously pressed, there is a problem that the food (f) of a soft material is deformed upward as the food (f) is pressed from the side at the end, whereas in the case of the present disclosure, when the food (f) passes through the pressurized space (S), the upper surface and both sides are pressed at the same time, thereby completely preserving the shape of the food (f) by suppressing the shape deformation of the bread crumb-coated food (f) in a specific direction.

Meanwhile, the coating apparatus according to the present disclosure can appropriately change the volume of the pressurized space (S) according to the type, shape, size, etc. of food (f).

For example, in the case of pork cutlet, bread powder is coated in a relatively thin and wide plate shape because it is put into the coating machine in a flat state in the pork tender process. Accordingly, the height and left and right width of the pressurized space (S) must be adjusted to correspond to the plate shape of pork, and in the case of foods (f) such as croquets and hot dogs, the volume of the pressurized space (S) must be properly configured through the side surface pressure unit 100 and the upper surface pressure unit 200.

Accordingly, the left and right width of the pressurized space (S) may be adjusted to be wider or narrower toward the rear end.

To this end, as shown in FIG. 6, each of the pair of side surface pressure units 100 may be largely illustrated as including a guide plate 110, a side driving roller 120, a side driven roller 130, a side pressure motor 140, and a side pressure belt 150.

First, the guide plate 110 is a plate-shaped member disposed at a predetermined distance from the upper surface of the installing stand 14 to the upper portion, and is not shown, but the driving roll mounting hole may be formed at the front end and the driven roll mounting hole at the rear end, respectively. The side driving roller 120 may be coupled to the driving roll mounting hole, and the side driven roller 130 may be coupled to the driving roll mounting hole in place.

The guide plate 110 may be formed through a plurality of guide holes 111 in the form of arcs with different lengths at the point between the side driving roller 120 and the side driven roller 130, and a separation rod 15 inserted into the guide holes 111 may be formed on the installing stand 14.

The separation rod 15 can guide the rotation of the side surface pressure unit 100 while separating and supporting the guide plate 110 from the upper surface of the installing stand 14 to the upper portion.

A separation groove 17 may be recessed on the outer circumferential surface of the separation rod 15, and the guide plate 110 may be inserted into the separation groove 17. Accordingly, the position movement of the guide plate 110 up and down may be restricted while being supported by the separation rod 15.

Next, the side pressure motor 140 is coupled to the side driving roller 120 coupled to the guide plate 110 while embedded in the installing stand 14 to rotate the side driving roller 120.

In this case, a shaft passing hole 16 through which a power output shaft 141 of the side pressure motor 140 passes can be penetrated on the upper surface of the installing stand 14.

Next, a side pressure belt 150 is a part that directly contacts the breadcrumbs on the side of the food (f) and is wound in an infinite orbit on the side driving roller 120 and the side driven roller 130, and when the side driving roller 120 rotates by the side pressure motor 140, it circulates between the side driving roller 120 and the side driven roller 130 in an infinite orbit.

In this case, a plurality of side idle rollers 112 can be installed in place in a line between the side driving roller 120 and the side driven roller 130 in the guide plate 110. In this case, the plurality of side idle rollers 112 support the side inner surface toward the food (f) of the side pressure belt 150 wound between the side driving roller 120 and the side driven roller 130 to give the straightness of the side pressure belt 150.

Accordingly, the side pressure belt 150 operates in the transfer direction and synchronous direction (the arrow direction shown in FIG. 7) of the food (f) being transported by the transfer conveyor 10 and presses the food (f) to a large area, so that it is equipped with a structure that can continuously press the side of the food (f) without stopping the food (f) at a specific point. Accordingly, there is an advantage of significantly improving productivity.

In addition, since the side surface pressure unit 100 does not press the food (f) while stopped in a specific area, it is structured to minimize the frictional resistance applied to the food (f), preventing the breadcrumbs on the food (f) from being removed from the food (f).

Meanwhile, the side driving roller 120 of the side surface pressure unit 100 is axially coupled on the side pressure motor 140 fixed to the installing stand 14, and the side driven roller 130 is provided in a structure that is not fixed from the installing stand 14, and thus, the side surface pressure unit 100 itself can be rotated at a certain angle based on a rotation of the side driving roller 120.

Accordingly, according to the rotation of the side surface pressure unit 100, the left and right width of the pressurized space (S) is adjusted to gradually widen or narrow toward the rear end.

For example, if the left and right widths of the food (f) are relatively small, when the rear ends of the pair of the side surface pressure units 100 rotate together as shown in FIG. 7, the left and right widths of the pressurized space (S) gradually narrow toward the rear end, so that the side of the food (f) of the relatively small food (f) can be pressed without difficulty.

In this case, a side pressure force is gradually applied to the food (f) entering the pressurized space (S) due to the structure of the pressurized space (S), which gradually narrows. Such a structure can prevent the deformation of the food (f) compared to the structure in which a large pressure is applied to the food (f) at once, and a large amount of breadcrumbs can be more closely adhered to the surface of the food (f), thereby making the breadcrumbs such as wet breadcrumbs that do not stick relatively well to the surface of the food (f) more robustly coated.

In addition, in the case of food (f) that does not require side coating of breadcrumbs, the side surface pressure unit 100 may be rotated in the outer direction of the transfer conveyor (10) so that the side surface pressure unit 100 does not reach the food (f).

On the other hand, the rotation range of the side surface pressure unit 100 may be limited within the arc length range of the guide holes 111, and in this case, since the plurality of guide holes 111 are configured to have different arc lengths, the side surface pressure unit 100 may be rotated at a predetermined angle within the range of the guide holes 111 selected according to the type of food (f) to ensure work convenience.

On the other hand, in order to control the tension of the side pressure belt 150, the guide plate 110 has a structure in which a tension control device 113 is cut inward from the opposite circumferential surface to which the side idle roller 112 is combined, and a tension control roller 114 is rotatably coupled in place and slidably coupled in the tension control device 113.

Depending on the type of food (f), the tension control roller 114 can roll into the inner surface of the side pressure belt 150, and the tension applied to the side pressure belt 150 can be adjusted by moving in position within the tension control device 113.

In addition, as the left and right width of the pressurized space (S) is adjusted, the upper and lower heights of the pressurized space (S) may be adjusted to rise or fall toward the rear end.

If the left and right width of the pressurized space (S) is adjusted by the side surface pressure unit 100, the vertical height of the pressurized space (S) can be adjusted by the upper surface pressure unit 200.

To this end, the upper surface pressure unit 200 may be exemplified as including an upper conveyor member 210, a support member 220, and an elevation member 230, as shown in FIG. 9.

First, the upper conveyor member 210 has a structure similar to that of the side surface pressure unit 100, and may include, for example, a support plate 211, an upper driving roller 212 that is rotatably coupled to the front end of the support plate 211, an upper driven roller 213 that is rotatably coupled to the rear end of the support plate 211, an upper pressure motor 215 coupled to the upper driving roller 212 to rotate the upper driving roller 212, and the upper pressure belt 214 wound around the upper driving roller 212 and the upper driven roller 213 in an infinite orbit shape.

The upper pressure belt 214 is a part that directly contacts the breadcrumbs on the upper surface of the food (f), and when the upper driving roller 212 rotates, it circulates between the upper driving roller 212 and the upper driven roller 213 in the form of an infinite orbit.

In this case, the support plate 211 can be installed in a row between the side driving roller 120 and the side driven roller 130 so that a plurality of upper idle rollers 216 can be rotated in place. In this case, the plurality of upper idle rollers 216 support the food (f) of the upper pressure belt 214 wound between the upper driving roller 212 and the upper driven roller 213 to give the straightness of the upper pressure belt 214.

Accordingly, the upper pressure belt 214 operates in the same direction as the transfer direction of the food (f) being transported by the transfer conveyor 10 and presses the food (f) to a large area, so it is equipped with a structure that can continuously press the upper surface of the food (f) without stopping the food (f) at a specific point.

In addition, since the upper surface pressure unit 200 does not press the food (f) in a stopped state in a specific part, the same as the side surface pressure unit 100 described above, it is structured to minimize friction resistance applied to the food (f), preventing the breadcrumbs on the food (f) from being removed from the food (f).

The front and rear ends of the upper conveyor member 210 may be supported by the support member 220 and the elevation member 230, respectively, and spaced apart from the upper part of the transfer conveyor 10.

In this case, the support member 220 may rotatably support the front end of the upper conveyor member 210, for example, the support member 220 may extend upward from the transfer frame 13 to rotatably support the upper driving roller 212.

In the case of the elevation member 230, it is responsible for elevating the rear end of the upper conveyor member 210 while supporting the rear end of the upper conveyor member 210.

For example, the elevation member 230 may consist of an elevation actuator that is coupled between the transfer frame 13 and the rear end of the upper conveyor member 210 and extends or compresses up and down.

With this structure, when the elevation member 230 operates, the rear end side of the upper conveyor member 210 can be rotated by a certain angle based on the upper conveyor member 210 itself.

Accordingly, according to the rotation of the upper conveyor member 210, the upper and lower widths of the pressurized space (S) are gradually widened or narrowed toward the rear end. Since the effect of such an action is the same as the effect of the side surface pressure unit 100 described above, a detailed description thereof will be omitted.

In summary, the coating machine according to the present disclosure constitutes the pressurized space (S) in which the breadcrumbs are pressed and adhered to the surface of the food (f), and when the food (f) passes through this pressurized space (S), the upper surface and both sides are pressed at the same time, thereby completely preserving the shape of the food (f) by suppressing the shape deformation of the food (f) in a specific direction. Since the powder on the food (f) is evenly pressed on the upper and side of the food (f), the breadcrumbs are uniformly coated around the food (f), and even after the coating, there is little shape deformation of the food (f), so that marketability is guaranteed.

In addition, the side pressing force is applied step by step to the food (f) entering the pressurized space (S) due to the structure of the pressurized space (S) that gradually narrows the width. Accordingly, it is possible to prevent deformation of the food (f) and to more closely adhere a large amount of breadcrumbs to the surface of the food (f), thereby coating the breadcrumb such as wet bread crumb that does not stick relatively well to the surface of the food (f) more firmly.

In addition, since the coating apparatus according to the present disclosure can appropriately change the volume of the pressurized space (S), even if the type, shape, and size of the food (f) vary, the breadcrumbs can be coated on the food (f) without difficulty.

The embodiment of this present invention described above is merely exemplary, and t Is to be understood that the invention is not limited to the disclosed embodiments, but, on the contrary, is intended to cover various modifications and equivalent arrangements included within the spirit and the scope of the appended claims. Accordingly, the scope of the present disclosure shall be determined only according to the attached claims. In addition, this invention should be understood to include the spirit of this invention defined by the attached claims and all modifications and equivalents and substitutes within the scope.

### DESCRIPTION OF REFERENCE NUMERALS

10: Transfer conveyor
20: bread crumb supply unit
30: pressure part
100: Side surface pressure unit
200: Upper surface pressure unit
110: Guide plate
120: Side driving roller
130: Side driven roller
140: Side pressure motor
150: Side pressure belt
210: Upper conveyor member
220: Support member
40: Support structure
f: Food
S: Pressurized space

1. A powder coating apparatus for food, comprising:
a transport conveyor that transports food in a row;
a breadcrumb supply unit that sprinkles breadcrumbs on the food that is transferred in a row at an upper part of the transfer conveyor; and
a pressure part installed on a path of the transfer conveyor and pressing the upper and side surfaces of the food with the breadcrumbs to adhere the breadcrumbs to the food.

2. The powder coating apparatus for food according to claim 1, wherein the pressure part comprises:
a pair of side surface pressure units installed to face each other with the transfer conveyor between them and pressurizing both sides of the food being transferred from the transfer conveyor; and
an upper surface pressure unit that presses the upper surface of the food passing through the pair of side surface pressure units

3. The powder coating apparatus for food according to claim 2, wherein a pressurized space is formed between the pair of side surface pressure units, the upper surface pressure unit, and the transfer conveyor, and the breadcrumbs adhere to both side surfaces and the upper surface of the food in the pressurized space.

4. The powder coating apparatus for food according to claim 3, wherein a left and right width of the pressurized space is adjusted to become wider or narrower toward a rear end.

5. The powder coating apparatus for food according to claim 3, wherein upper and lower heights of the pressurized space are adjusted to rise or fall toward the rear end.
